(19) United States
(12) Patent Application Publication
(10) Pub. No.: US 2009/0298960 A1
(43) Pub. Date: Dec. 3, 2009

(54) DUCTILE STRUCTURAL FOAMS

(75) Inventors: Xaver Muenz, Heidelberg (DE); Larissa Bobb, Leimen (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/426,446

(22) Filed: Apr. 20, 2009

Related U.S. Application Data
(63) Continuation of application No. PCT/EP2007/058494, filed on Aug. 16, 2007.

(30) Foreign Application Priority Data
Oct. 24, 2006 (DE) 102006050697.9

(51) Int. Cl. C08L 63/00; C08G 59/00; C08K 3/34

(52) U.S. Cl. 521/91; 521/189; 521/135; 264/54

(57) ABSTRACT

A composition containing at least one epoxy resin, at least one phenol compound that is solid at room temperature, at least one polyether amine, at least one propellant, at least one hardener, at least one filler suitable for manufacturing structural foams that are notable for ductile behavior under compressive or flexural loading, i.e. an elastic deformation is observed under compressive load or in the three-point flexural test.

This application is a continuation under 35 U.S.C. Sections 365(c) and 120 of International Application No. PCT/EP2007/058494, filed Aug. 16, 2007 and published on May 2, 2008 as WO 2008/049660, which claims priority from German Patent Application No. 102006050697.9 filed Oct. 24, 2006, which are incorporated herein by reference in their entirety.

The present invention relates to expandable, thermally curable compositions based on epoxy resins, and to methods for stiffening and/or reinforcing components having thin-walled structures, in particular body parts in vehicle engineering using these structural foams.

Lightweight components for dimensionally consistent series production with high stiffness and structural strength are necessary for many areas of application. In vehicle engineering in particular, because of the weight saving desirable in that context, there is a great demand for lightweight components made of thin-walled structures that nevertheless possess sufficient stiffness and structural strength. One approach to achieving high stiffness and structural strength with the lowest possible component weight utilizes hollow parts that are produced from relatively thin sheet metal or plastic panels. Thin-walled metal sheets tend to deform easily, however. It has therefore been known for some time to foam out this cavity in hollow-body structures with a structural foam, which on the one hand prevents or minimizes deformation, and on the other hand enhances the strength and stiffness of these parts. For planar parts of automobile bodies such as doors, roof parts, engine compartment hoods, or trunk lids, it is also known to increase the stiffness and strength of these parts by applying sheet-form laminates, based on expandable or non-expandable epoxy resins or polyurethane resins, onto these parts, and joining them fixedly thereto.

Foamed reinforcing and stiffening agents of this kind usually either are metal foams, or contain a thermally curable resin or binders such as, for example, epoxy resins. These compositions as a rule contain a propellant, fillers, and reinforcing fillers such as, for example, hollow microspheres made of glass. Such foams preferably have, in the foamed and cured state, a density from 0.3 to 0.7 g/cm³. These foams are said to withstand temperatures of more than 130° C., preferably more than 150° C., at least for a short time, without damage. Foamable, thermally curable compositions of this kind generally contain further constituents such as curing agents, process adjuvants, stabilizers, dyes or pigments, optionally UV absorbers and adhesion-intensifying constituents.

U.S. Pat. No. 4,978,562 describes a reinforcing door beam of low specific weight made of a composite material comprising a metal tube that is partly filled with a polymer of low specific weight having a cellular structure. It is proposed to mix curable resins on the basis of epoxy resins, vinyl ester resins, unsaturated polyester resins, and polyurethane resins with the corresponding hardeners, fillers, and cell-forming agents in an extruder, to cure said mixture to form a core, and to introduce it into the metal tube so that the core is immobilized in the tube mechanically or by frictional forces. Alternatively, the polymer core can be manufactured from liquid or pasty polymeric material by casting, and pressed into the tube. Reactive, heat-curable, and thermally expanding shaped members are not disclosed.

U.S. Pat. No. 4,769,391 describes a preshaped composite insert for insertion into a hollow structural member. This insert contains a plurality of thermoplastic granules made of a mixture of a thermoplastic resin and non-expanded, expandable hollow microspheres, and a matrix of expanded polystyrene that contains the aforesaid granules. The thermoplastic resin of the granules can be a thermoplastic such as, for example, a thermoplastic polyester, or it can be a heat-curable epoxy resin. After insertion of the part into the hollow member that is to be filled, the component is heated to a temperature that brings about “vaporization” of the expanded polystyrene, “vaporization” meaning here degradation of the expanded polystyrene to a thin film or soot. At the same time, the thermoplastic granules expand and, optionally, cure; depending on the degree of expansion of the granules, cavities of varying size remain between the individual expanded granulate particles.

WO 89/08678 describes a method and compositions for reinforcing structural members, the polymeric reinforcing material being a two-component epoxy system in which the one component is a dough-like substance based on epoxy resins, and the second component is a mixture of fillers, a color pigment, and a liquid curing agent of doughy consistency. Immediately before introduction of the reinforcing material into the hollow structure, the two components are mixed, conveyed into the hollow member structure, and cured; optionally, the hollow member structure can be preheated.

WO 98/15594 describes foamed products for applications in the automobile industry, based on preferably liquid, two-component epoxy systems in which the one component is made up of a liquid epoxy resin and metal carbonates or bicarbonates, and the other component of pigments, hollow spheres optionally, and phosphoric acid. When the two components are mixed, these compositions cure and foam up. Applications for reinforcing or stiffening hollow structures are not disclosed.

WO 2004 065485 A1 describes compositions that contain at least one liquid epoxy resin, at least one solid epoxy resin, at least one propellant, at least one hardener, and at least one mica-containing filler. These compositions yield expandable, thermally curable binder systems that can be used, without the addition of hollow glass spheres, for the manufacture of stiffening and reinforcing layered members and for the manufacture of stiffening and reinforcing shaped members. These layered members according to the present invention are suitable for stiffening and reinforcing components in particular in automotive engineering, such as body frames, doors, trunk lids, hoods, and/or roof parts. The shaped members manufacturable from these binders are furthermore suitable for stiffening and reinforcing metal hollow structures, in particular hollow body parts such as body frames, body supports and columns, or doors in automotive engineering. No indication is given as to the fracture-mechanical properties of the structural foams described in WO 2004 065485 A1.

### BRIEF DESCRIPTION OF THE DRAWINGS

FIGS. 1 and 3 depict the compressive stress curves at 0° C. and −20° C. for test articles manufactured using the Comparative Example. For better clarity, the curves for the individual measurements were each plotted with a 10 mm crosshead travel offset.

FIGS. 2 and 4 depict the compressive stress curves respectively at 0° C. and −20° C. for test articles manufactured using Example 1 according to the present invention. For better clarity, the curves for the individual measurements were once again each plotted with a 10 mm crosshead travel offset.

FIG. 5 shows comparison photos of test articles after the compressive strength test. Brittle fracture of a test article manufactured using the Comparative Example is shown on the left. On the right in FIG. 5, a test article manufactured using Example 1 according to the present invention shows only a slight ductile deformation.

FIG. 6 shows comparison photos of test articles after the compressive strength test at −20 degrees C. Brittle fracture of a test article manufactured using the Comparative Example is shown on the left, while once again only a slighter ductile deformation is observed in the test article manufactured according to the present invention, shown on the right in FIG. 6.

### DETAILED DESCRIPTION

Against the background of the aforesaid existing art, the inventors have addressed the object of making available compositions for shaped parts for reinforcing and/or stiffening panels or metal hollow members that
exhibit ductile behavior from −20 to +80° C., such that
no decrease in force level is to occur.
   This makes possible improved finite element analysis (FEA) calculations, since a constant force level over the deformation range is achieved. This opens up new areas of application, since what occurs under load is a defined deformation of the structural foam rather than brittle shattering of the foam at low deformation levels.

The manner in which the object is achieved may be inferred from the claims. It includes substantially in making available binders for the manufacture of expandable, thermally curable shaped members that contain

a) at least one epoxy resin,

b) at least one phenol compound that is solid at room temperature,

c) at least one polyether amine,

d) at least one propellant,

e) at least one hardener, and

f) at least one filler.

By preference, thermally expandable shaped members that can be used to stiffen and/or reinforce metal components are manufactured from the expandable, thermally curable compositions, using the injection molding method at low pressures and low temperatures.

A further subject of the present invention is therefore a method for stiffening and/or reinforcing metal components, in particular components for “white goods” (household or kitchen appliances), which method contains the following essential method steps.

In a first step, the aforementioned binder constituents are mixed homogeneously at temperatures below 110° C., and then transferred into an injection molding unit. For that purpose, the homogeneous mixture is either extruded as a bulk compound into storage and transport containers or, in a further embodiment, the mixture can be extruded as a thick strand (in the form of “sausages”) and, optionally, stored temporarily. Alternatively, the mixture can be extruded in granulate form.

In a subsequent step, the binder mixture is injected into an injection mold at temperatures from 60° C. to 110° C., by preference at temperatures from 70° C. to 90° C., under temperature-controlled conditions. Optionally, there is present in that mold a support made of metal or thermoplastic materials, onto which the expandable binder is injected. Cooling of the shaped part to temperatures below 50° C. then occurs. Upon unmolding, the surface of the expandable binder is tack-free, so that the expandable shaped members can be packaged without particular outlay and, even in summer, withstand without difficulty long transport distances in southern countries with no need for the use of refrigerated vehicles.

For final use, the expandable shaped member is applied onto the planar metallic substrate or introduced into the cavity to be stiffened, for example a vehicle body, and immobilized. As is known, in the subsequent process heat of the painting ovens the vehicle body is brought to temperatures between 110° C. and 200° C.; with this heating, the volume of the structural foam expands by 50 to 300% and the reaction resin matrix cures to a thermoset plastic.

A further subject of the present invention is therefore the use of the expandable shaped members to stiffen and reinforce planar sheet-metal parts and/or metallic hollow structures, in particular hollow body parts such as body frames, body beams, body columns, as well as wider joints and gaps between body parts in automobile engineering, or of components for “white goods.”

The binder system that is particularly suitable for an injection molding method for manufacture of the hot-curable, thermally expandable shaped members is described in further detail below.

Numerous polyepoxides that contain at least two 1,2-epoxy groups per molecule are suitable as epoxy resins. The epoxy equivalent of these polyepoxides can vary between 150 and 50,000, by preference between 170 and 5000. The polyepoxides can in principle be saturated, unsaturated, cyclic or acyclic, aliphatic, alicyclic, aromatic, or heterocyclic polyepoxide compounds. Examples of suitable polyepoxides include the polyglycidyl ethers, which are manufactured by reacting epichlorohydrin or epibromohydrin with a polyphenol in the presence of alkali. Polyphenols suitable for this are, for example, resorcinol, catechol, hydroquinone, bisphenol A (bis-(4-hydroxyphenyl)-2,2-propane), bisphenol F (bis-(4-hydroxyphenyl)methane), (bis-(4-hydroxyphenyl)-1,1-isobutane), 4,4′-dihydroxybenzophenone, bis(4-hydroxyphenyl)-1,1-ethane, 1,5-hydroxynaphthalene. Further polyphenols that are suitable as a basis for the polyglycidyl ethers are the known condensation products of phenol and formaldehyde or acetaldehyde, of the novolac resin type.

The following polyepoxides can also be used at least in part: polyglycidyl esters of polycarboxylic acids, for example reaction products of glycidol or epichlorohydrin with aliphatic or aromatic polycarboxylic acids such as oxalic acid, succinic acid, glutaric acid, terephthalic acid, or dimer fatty acid.

Optionally, the binder composition according to the present invention can contain reactive diluents. Reactive diluents for the purpose of this invention are low-viscosity substances (glycidyl ethers or glycidyl esters) containing epoxy groups and having an aliphatic or aromatic structure. These reactive diluents on the one hand can serve to lower the viscosity of the binder system above the softening point, and on the other hand can serve to control the pre-gelling process in injection molding. Typical examples of reactive diluents to be used according to the present invention are mono-, di- or triglycidyl ethers of C₆ to C₁₄ monoalcohols or alkylphenols, as well as the monoglycidyl ethers of cashew-shell oil; diglycidyl ethers of ethylene glycol, diethylene glycol, triethylene glycol, tetraethylene glycol, propylene glycol, dipropylene glycol, tripropylene glycol, tetrapropylene glycol, 1,4-butylene glycol, 1,5-pentanediol, 1,6-hexanediol, and cyclohexanedimethanol; triglycidyl ethers of trimethylolpropane, and the glycidyl esters of C₆ to C₂₄ carboxylic acids, or mixtures thereof.

Suitable phenol compounds are solid at room temperature (i.e. in a temperature range between 18° C. and 25° C., by preference at 22° C.) and have a molecular weight (Mₙ) between 2800 and 9000. By preference, the phenol compounds are difunctional with respect to the phenol groups, i.e. they have a phenolic hydroxyl group content of between 1400 and 2500 mmol/kg. All phenol compounds that meet the aforesaid criteria are suitable in principle, although reaction products of difunctional epoxy compounds with bisphenol A at a stoichiometric excess are very particularly preferred.

Polyether amines that can be used in preferred fashion are amino-terminated polyalkylene glycols, in particular the difunctional amino-terminated polypropylene glycols, polyethylene glycols, or copolymers of propylene glycol and ethylene glycol. These are also known by the name “Jeffamines” (trade name of the Huntsman company). Also suitable are the difunctional amino-terminated polyoxytetramethylene glycols that are also called poly-THE. The molecular weight range (Mₙ) of the preferably difunctional polyether amines (based on the primary amino groups) is between 900 and 4000, by preference between 1500 and 2500.

Suitable as propellants are, in principle, all known propellants such as, for example, the “chemical propellants” that release gases by decomposition, or “physical propellants,” i.e. expanding hollow spheres. Examples of the former propellants are azobisisobutyronitrile, azodicarbonamide, dinitrosopentamethylenetetramine, 4,4′-oxybis(benzenesulfonic acid hydrazide), diphenylsulfone-3,3′-disulfohydrazide, benzene-1,3-disulfohydrazide, p-toluenesulfonylsemicarbazide. Particularly preferred, however, are the expandable hollow plastic microspheres based on polyvinylidene chloride copolymers or acrylonitrile-(meth)acrylate copolymers; these are available commercially, for example, under the names “Dualite” and “Expancel,” from the companies styled Pierce & Stevens and Casco Nobel, respectively.

Thermally activatable or latent hardeners for the epoxy resin binder system are used as hardeners. These can be selected from the following compounds: guanidines, substituted guanidines, substituted ureas, melamine resins, guanamine derivatives, cyclic tertiary amines, aromatic amines, and/or mixtures thereof. The hardeners can be involved stoichiometrically in the hardening reaction, but they can also be catalytically active. Examples of substituted guanidines are methylguanidine, dimethylguanidine, trimethylguanidine, tetramethylguanidine, methylisobiguanidine, dimethylisobiguianidine, tetramethylisobiguanidine, hexamethylisobiguianidine, heptamethylisobiguanidine, and very particularly cyanoguanidine (dicyanodiamide). Representatives of suitable guanamine derivatives that may be cited are alkylated benzoguanamine resins, benzoguanamine resins, or methoxymethylethoxymethylbenzoguanamine. The selection criterion for the heat-curing binder system according to the present invention is, of course, the low solubility of these substances in the binder system at room temperature, so that solid, finely ground hardeners are preferable here; dicyanodiamide is particularly suitable. This ensures good shelf stability for the composition.

In addition to or instead of the aforesaid hardeners, catalytically active substituted ureas can be used. These are, in particular, p-chlorophenyl-N,N-dimethylurea (Monuron), 3-phenyl-1,1-dimethylurea (Fenuron), or 3,4-dichlorophenyl-N,N-dimethylurea (Diuron). In principle, catalytically active tertiary acrylamines or alkylamines such as, for example, benzyldimethylamine, tris(dimethylamino)phenol, piperidine, or piperidine derivatives can also be used, but these often have too high a solubility in the binder system, so that usable shelf stability for the single-component system is not achieved in this case. In addition, a variety of (by preference, solid) imidazole derivatives can be used as catalytically active accelerators. Representatives that may be named are 2-ethyl-2-methylimidazole, N-butylimidazole, benzimidazole, and N—C₁— to —C₁₂ alkylimidazoles or N-arylimidazoles. Adducts of amino compounds with epoxy resins are also suitable as accelerating additives to the aforesaid hardeners. Suitable amino compounds are tertiary aliphatic, aromatic, or cyclic amines. Suitable epoxy compounds are, for example, polyepoxides based on glycidyl ethers of bisphenol A or F, or of resorcinol. Concrete examples of such adducts are adducts of tertiary amines such as 2-dimethylaminoethanol, N-substituted piperazines, N-substituted homopiperazines, N-substituted aminophenols with di- or polyglycidyl ethers of bisphenol A or F or of resorcinol. Amine-epoxy adducts of this kind are described, for example, in the following documents: JP 59-053526, U.S. Pat. No. 3,756,984, U.S. Pat. No. 4,066,625, U.S. Pat. No. 4,268,656, U.S. Pat. No. 4,360,649, U.S. Pat. No. 4,542,202, U.S. Pat. No. 4,546,155, U.S. Pat. No. 5,134,239, U.S. Pat. No. 5,407,978, U.S. Pat. No. 5,543,486, U.S. Pat. No. 5,548,058, U.S. Pat. No. 5,430,112, U.S. Pat. No. 5,464,910, U.S. Pat. No. 5,439,977, U.S. Pat. No. 5,717,011, U.S. Pat. No. 5,733,954, U.S. Pat. No. 5,789,498, U.S. Pat. No. 5,798,399, U.S. Pat. No. 5,801,218, EP 950 677.

The thermally curable compositions according to the present invention can additionally contain finely particulate thermoplastic copolymers. These thermoplastic polymer powders can in principle be selected from a plurality of finely particulate polymer powders; examples that may be mentioned are vinyl acetate homopolymer, vinyl acetate copolymer, ethylene-vinyl acetate copolymer, vinyl chloride homopolymer (PVC), or copolymers of vinyl chloride with vinyl acetate and/or (meth)acrylates, styrene homo- or copolymers, (meth)acrylate homo- or copolymers, or polyvinylbutyral. Particularly preferred in this context are ethylene-vinyl acetate copolymers that, optionally, can contain further comonomers such as, for example, carbon monoxide. The melting range of the aforesaid copolymers is intended to be between 40° C. and 60° C. For flexibilization, solid rubbers can also be used as finely particulate thermoplastic copolymers. They have a molecular weight Mₙ of 100,000 or higher. Examples of suitable solid rubbers are polybutadiene, styrene-butadiene rubber, butadiene-acrylonitrile rubber, EPDM, synthetic or natural isoprene rubber, butyl rubber, or polyurethane rubber. Partly crosslinked solid rubbers based on isoprene-acrylonitrile or butadiene-acrylonitrile copolymers are particularly suitable. The proportion of solid rubber can be 0 to 15 wt %, by preference 2 to 10 wt %, of the entire binder composition.

As a rule, the thermally curable compositions according to the present invention also contain fillers known per se, for example the various ground or precipitated chalks, carbon black, calcium-magnesium carbonates, barite, and in particular silicate fillers of the aluminum-magnesium-calcium silicate type, for example wollastonite, chlorite. By preference, mica-containing fillers can also be additionally used; very particularly preferred in this context is a so-called two-component filler made up of muscovite mica and quartz, with a low heavy-metal content.

The goal of the present invention is to use the expandable, thermally curable compositions for the manufacture of shaped members for structures of low specific weight. They therefore preferably contain, in addition to the aforesaid “normal” fillers, so-called lightweight fillers, which are selected from the group of the hollow metal spheres such as, for example, hollow steel spheres, hollow glass spheres, fly ash (fillite), hollow plastic spheres based on phenol resins, epoxy resins, or polyesters, expanded hollow microspheres having wall material made of (meth)acrylic acid ester copolymers, polystyrene, styrene-(meth)acrylate copolymers, and in particular of polyvinylidene chloride, as well as copolymers of vinylidene chloride with acrylonitrile and/or (meth)acrylic acid esters, hollow ceramic spheres, or organic lightweight fillers of natural origin such as ground nut shells, for example the shells of cashew nuts or coconuts, or peanut shells, as well as cork flour or powdered coke. Particularly preferred in this context are those lightweight fillers based on hollow microspheres that ensure, in the cured shaped-member matrix, high compressive strength for the shaped member.

In a particularly preferred embodiment, the compositions for the thermally curable, expandable shaped members additionally contain fibers based on aramid fibers, carbon fibers, metal fibers (made, for example, of aluminum), glass fibers, polyamide fibers, polyethylene fibers, or polyester fibers, these fibers by preference being pulp fibers or staple fibers that have a fiber length between 0.5 and 6 mm and a diameter from 5 to 20 μm. Polyamide fibers of the aramid fiber type, or also glass fibers, are particularly preferred in this context.

The adhesive compositions according to the present invention can further contain common additional adjuvants and additives such as, for example, plasticizers, reactive diluents, rheology adjuvants, crosslinking agents, adhesion promoters, aging protection agents, stabilizers, and/or color pigments. The quantitative ratios of the individual components can vary within relatively wide limits depending on the requirements profile for the shaped member in terms of its processing properties, flexibility, required stiffening effect, and adhesive bond to the substrates.

Typical ranges for the essential components of the binder are:

| | |
|---|---|
| (a) solid epoxy resin | 2 to 65 wt %, |
| (b) phenol compound | 1 to 30 wt %, by preference 5 to |
| | 10 wt %, |
| (c) polyether amine | 0.5 to 15 wt %, by preference 2 to |
| | 10 wt % |
| (d) propellant | 0.1 to 5 wt %, |
| (e) hardener and accelerator | 1.5 to 5 wt %, |
| (f) mica-containing filler | 0 to 40 wt %, by preference 1 to |
| | 30 wt % |
| (g) further fillers | 5 to 20 wt %, |
| (h) reactive diluent | 0 to 15 wt %, by preference 0 to |
| | 10 wt %, |
| (i) ethylene-vinyl acetate copolymer | 0 to 10 wt %, by preference 1 to |
| | 10 wt % |
| (j) fibers | 0 to 30 wt %, by preference 0 to |
| | 10 wt % |
| (k) pigments | 0 to 1 wt %, |

the sum of the total constituents yielding 100 wt %.

For simplified conveyance and further processing, the expandable, thermally curable composition is by preference present in granulate form prior to manufacture of the actual shaped parts.

The present invention further encompasses methods for the manufacture of expandable, thermally curable shaped members from the composition according to the present invention described above. Two method variants are possible in this context:

Variant I):
a) mix the composition constituents according to at least one of Claims 1 to 15 at temperatures below 110° C., by preference between 80 and 95° C.,
b) extrude the composition at temperatures below 110° C., by preference 80° C. to 95° C., forming a granulate, optionally onto a cooled metal belt,
c) cool the granulate thus formed,
d) optionally, store the granulate temporarily, by preference in container, big bags, barrels, or sacks,
e) convey the granulate into an injection molding machine,
f) melt the granulate at temperatures below 110° C., and inject the melt into the predetermined mold of the injection molding machine,
g) cool the shaped member that is formed, and remove the shaped member from the mold.

Variant II):
a) mix the composition constituents according to at least one of Claims 1 to 15 at temperatures below 110° C., by preference between 80 and 95° C.,
b) extrude the composition at temperatures below 110° C., by preference 80° C. to 95° C., producing a shaped intermediate product,
c) cool the intermediate product thus formed,
d) optionally, store the shaped intermediate product temporarily, by preference in shelves or barrels,
e) convey the shaped intermediate product into the reservoir of an injection molding machine,
f) melt the shaped intermediate product at temperatures below 110° C., and inject the melt into the predetermined mold of the injection molding machine,
g) cool the shaped member that is formed, and remove the shaped member from the mold.

Also within the scope of the present invention is an injection-molded shaped member that has been manufactured according to one of these method variants.

The structural foams manufacturable from the compositions according to the present invention are notable for ductile behavior under compressive or flexural loading, i.e. an elastic deformation is observed under a compressive load or in the three-point flexural test, whereas the structural foams according to the existing art are very brittle and splinter under load in the temperature range from −40 to approx. 80° C. The latter structural foams exhibit an undefined shattering, i.e. a brittle breakdown of the structure, once the tearing force has been exceeded and the load is elevated further. The structural foams manufacturable according to the present invention exhibit, under load, the formation of a force plateau with little tearing force superelevation (deformation rather than fracture). The energy introduced in the context of a crash can thus be dissipated or absorbed in defined fashion.

Upon compressive loading (upsetting) of the structural foams manufacturable according to the present invention in the so-called compression test, even at −20° C. a steep rise in the compressive stress is first observed, to values of at least 15 MPa, in particular to values between 20 and 30 MPa (at a 10 to 15% deformation of the test article); and upon further deformation of the test article to 50%, this force level is maintained, i.e. no significant falloff in the force level occurs. At 0° C. the corresponding compressive stresses are 15 to 25 MPa (at a 10 to 15% deformation of the test article) and 20 to 36 MPa (at a 50% deformation of the test article). The compressive strength is determined in accordance with ASTM D 1621.

The fracture behavior of these structural foams is thus accessible to FEA calculations.

The present invention accordingly also encompasses a structural foam characterized by a compressive stress of at least 5 MPa, by preference at least 10 MPa and in particular at least 15 MPa, at a 10 to 15% deformation of the test article at −20° C., and no significant falloff in the force level up to a 50% deformation of the test article at −20° C., measured in accordance with ASTM D 1621; and a structural foam that also exhibits these properties at 0° C. A structural foam having these properties is obtainable by expansion and thermal curing of an expandable, thermally curable composition according to the present invention as described above.

The compositions according to the present invention can be used not only for three-dimensional, non-tacky frame structure stiffeners. For two-dimensional stiffening as well, which is carried out at present using panels reinforced with tacky glass-fiber mats, it is also of considerable advantage if the stiffening material does not already fracture at low deformation levels but instead complies with the deformation for as long as possible. Surprisingly, a deformation return has additionally been observed in the materials according to the present invention if the deformation has not gone beyond the fracture range of the stiffening material. This property is especially desirable in vehicle engineering. The present invention therefore encompasses the use of the shaped members, obtainable as described above, for stiffening and reinforcing components, in particular components for white goods, or of body components such as body frames, doors, trunk lids, hoods, and/or roof parts in automotive engineering, as well as a correspondingly reinforced vehicle or metal component.

The exemplifying embodiments below are intended to explain the invention further; the selection of examples is not intended to represent any limitation of the scope of the subject matter of the invention. They are intended merely to present, in the manner of a model, some embodiments and advantageous effects of the invention.

All the quantitative indications given in the examples below are parts by weight or percentages by weight unless otherwise indicated.

### EXAMPLES

The binder compositions listed in the table below were mixed in an evacuatable planetary mixer until homogeneous, action having been taken to ensure that the temperature of the compound did not exceed 70° C.

TABLE 1

| | Example 1 | Comparative Example |
|---|---|---|
| Solid epoxy resin ¹⁾ | 55.00 | 38.00 |
| Liquid epoxy resin ¹⁾ | | 5.00 |
| Flexibilized epoxy resin ¹⁾ | | 15.00 |
| Polyether amine ²⁾ | 5.00 | — |
| Phenol compound ³⁾ | 9.00 | — |
| EVA copolymer ⁴⁾ | 6.00 | — |
| Chalk, precipitated, coated | 7.80 | 7.4 |
| Fibers | | 0.5 |
| Hollow glass spheres | | 26.5 |
| Filler ⁵⁾ | 8.00 | — |
| Carbon black paste | 0.60 | 0.4 |
| Dicyanodiamide | 1.50 | 2.5 |
| Accelerator ⁶⁾ | 0.60 | 1.5 |
| Propellant ⁷⁾ | 2.00 | 1.2 |
| Pyrogenic silicic acid ⁸⁾ | 4.50 | 2 |

¹⁾ Bisphenol A-based epoxy resin, solid at room temperature, molecular weight (Mₙ) 1150, melting range 64 to 74° C.; bisphenol A-based epoxy resin, liquid at room temperature, molecular weight (Mₙ) approx. 188; flexibilized epoxy resin according to the teaching of WO 00/52086.
²⁾ Polyoxypropylene glycol having terminal primary amino groups, equivalent weight against isocyanate groups 1030 g/eq.
³⁾ Linear molecular structure; concentration of phenolic OH groups 2000 mmol/kg, melting range 80 to 90° C.
⁴⁾ Ethylene-vinyl acetate-carbon monoxide copolymer, crystalline; melting temperature 45° C.
⁵⁾ Two-component filler made of muscovite mica and quartz.
⁶⁾ Finely ground accelerator (amino adduct with epoxy resin having epoxy and tertiary amino groups).
⁷⁾ Propellant (Expancel 091 DU 140 hollow plastic spheres, Pierce & Stevens company).
⁸⁾ Cab-O-Sil TS 720 pyrogenic silicic acid, Cabot company.

Test articles for compressive strength measurement in accordance with ASTM D 1621 were manufactured from the compositions according to the present invention as described in Example 1 and from the compositions according to the comparative example, and were exposed to a temperature of 175° C. (laboratory drying oven) for 25 minutes in order to expand and cure the test articles. Compressive strengths in accordance with ASTM D 1621 were then measured on the test articles at various temperatures. The measurement results for 0° C. and −20° C. are presented in FIGS. 1 to 4 as curves for compressive stress as a function of the crosshead travel of the tester. At least two measurements were carried out for each composition and temperature.

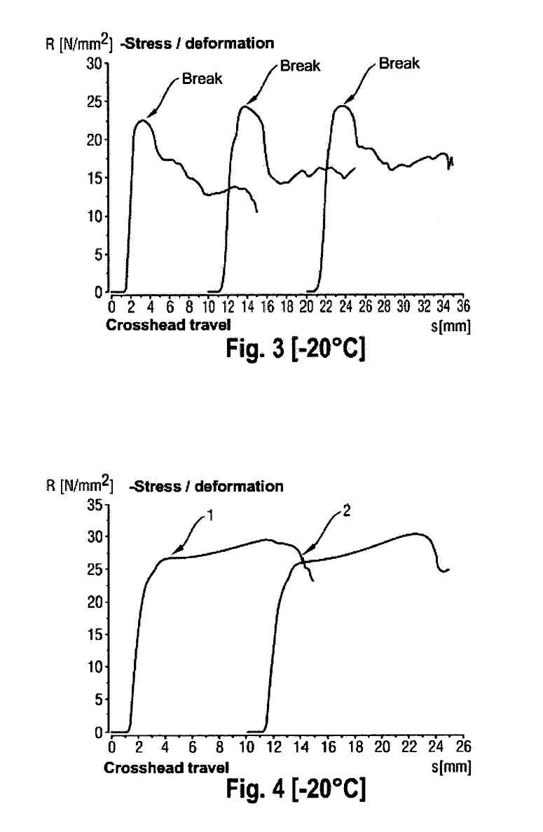

FIGS. 1 and 3 depict the compressive stress curves at 0° C. and −20° C. for the test articles manufactured using the comparative example. For better clarity, the curves for the individual measurements were each plotted with a 10 mm crosshead travel offset.

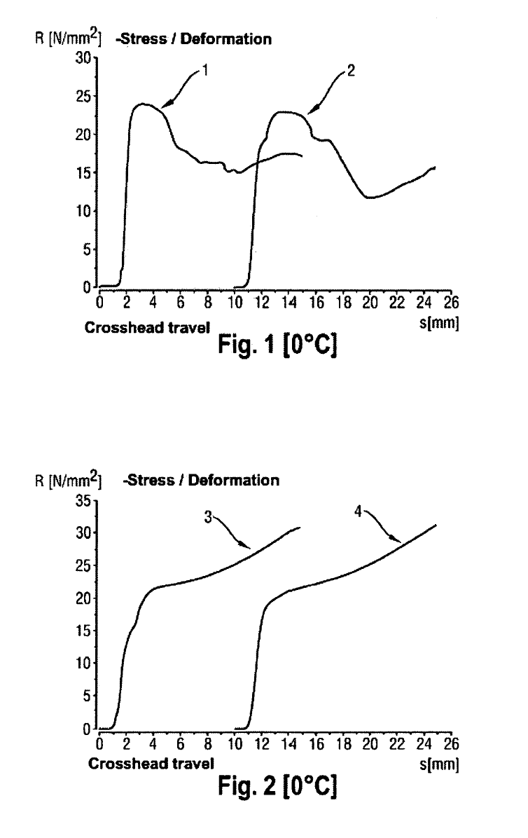

FIGS. 2 and 4 depict the compressive stress curves respectively at 0° C. and −20° C. for the test articles manufactured using the example according to the present invention. For better clarity, the curves for the individual measurements were once again each plotted with a 10 mm crosshead travel offset.

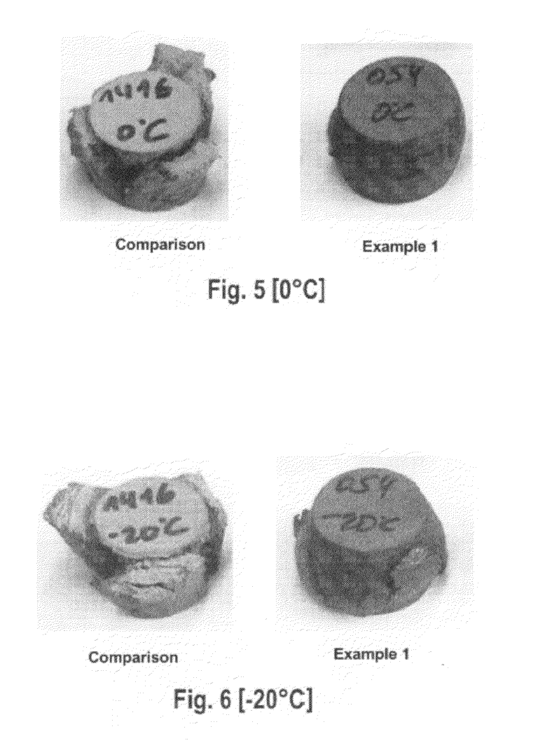

It is apparent from a comparison of curves (3) and (4) in FIG. 2 of the example according to the present invention that after the steep rise in compressive stress during the first 3 mm of deformation travel, upon further deformation a further steady rise in compressive stress may be observed. With the comparative example, after the first steep rise there is a sharp downturn in compressive stress (see curves (1) and (2) in FIG. 1). This is attributable to incipient brittle fracture of the test articles; in this context, compare the image of the test article on the left after the compressive strength test in FIG. 5. With the test article according to the present invention, on the right in FIG. 5, only a slight ductile deformation is observed.

The advantage of the test articles manufactured according to the present invention becomes even clearer in the compressive strength test at −20° C.: FIG. 3 presents the results for the three test articles according to the comparative experiment. A drastic falloff in compressive strength is observed here after approximately 2 mm of crosshead travel, as a result of brittle fracture (curve location labeled “break”), whereas with the test articles according to the present invention, a further continuous rise in compressive strength is observed as deformation proceeds (curve location labeled “k”). In FIG. 6, the test article from the comparative experiment, deformed by brittle fracture, is shown on the left, while once again only a slighter ductile deformation is observed in the test article on the right in FIG. 6, manufactured according to the present invention.

1. An expandable, thermally curable composition comprising constituents:
a) at least one epoxy resin,
b) at least one phenol compound that is solid at room temperature,
c) at least one polyether amine,
d) at least one blowing agent,
e) at least one hardener,
f) at least one filler.

2. The expandable, thermally curable composition according to claim 1, additionally comprising an ethylene-vinyl acetate copolymer.

3. The expandable, thermally curable composition according to claim 1, wherein said phenol compound has a melting point above 60° C. and has a phenolic hydroxyl group content of between 1400 and 2500 mmol/kg.

4. The expandable, thermally curable composition according to claim 1, wherein said epoxy resin comprises a glycidyl ether of a polyphenol.

5. The expandable, thermally curable composition according to claim 1, wherein said polyether amine is a difunctional polyoxypropylene having terminal primary amino groups.

6. The expandable, thermally curable composition according to claim 1, wherein said epoxy resin is solid at room temperature and has a molecular weight (Mₙ) above 700, and said polyether amine has an average molecular weight (Mₙ) from 1000 to 3000.

7. The expandable, thermally curable composition according to claim 1, wherein:
(a) the at least one epoxy resin, comprises a solid epoxy resin present in an amount of 2 to 65 wt %;
(b) the at least one phenol compound is present in an amount of 1 to 30 wt %;
(c) the at least one polyether amine is present in an amount of 0.5 to 15 wt %;
(d) the at least one blowing agent is present in an amount of 0.1 to 5 wt %;
(e) the at least one hardener, optionally further comprising an accelerator, is present in an amount of 1.5 to 5 wt %;
(f) the at least one filler comprises:
1) 0 to 40 wt % of a mica-containing filler; and
2) 5 to 20 wt % of further fillers, different from the mica-containing filler;
and optionally further comprises:
(g) 0 to 15 wt % of a reactive diluent;
(h) 0 to 10 wt % of an ethylene-vinyl acetate copolymer;
(i) 0 to 30 wt % of fibers; and
(j) 0 to 1 wt % of pigments;
wherein the sum of the total constituents yield 100 wt %.

8. A method for manufacturing expandable, thermally curable shaped members, comprising steps of:
a) providing a composition as claimed in claim 1, optionally by mixing the constituents at temperatures below 110° C.;
b) extruding, optionally onto a cooled belt, the composition at temperatures below 110° C., forming a granulate;
c) cooling the granulate thus formed;
d) optionally, storing the granulate temporarily;
e) conveying the granulate into an injection molding machine;
f) melting the granulate, at temperatures below 110° C., to form a melt and injecting the melt into a predetermined mold of the injection molding machine to form a shaped member;
g) cooling the shaped member, and removing the shaped member from the mold.

9. A method for manufacturing expandable, thermally curable shaped members, comprising steps of:
a) providing a composition as claimed in claim 1, optionally by mixing the constituents at temperatures below 110° C.;
b) extruding the composition at temperatures below 110° C., producing a shaped intermediate product,
c) cooling the shaped intermediate;
d) optionally, storing the shaped intermediate product temporarily;
e) conveying the shaped intermediate product into an injection molding machine;
f) melting the shaped intermediate product, at temperatures below 110° C., to form a melt and injecting the melt into a predetermined mold of the injection molding machine to form a shaped member;
g) cooling the shaped member, and removing the shaped member from the mold.

10. An injection-molded shaped member manufactured according to claim 8.

11. An injection-molded shaped member manufactured according to claim 9.

12. A vehicle or metal component stiffened or reinforced with a shaped member in accordance with claim 10.

13. A vehicle or metal component stiffened or reinforced with a shaped member in accordance with claim 11.

14. A structural foam, having a compressive stress of at least 5 MPa, at a 10 to 15% deformation of a test article comprising the structural foam, and no significant falloff in force level up to a 50% deformation of a test article comprising the structural foam, measured in accordance with ASTM D 1621 at a test temperature of −20° C. or 0° C.

15. A structural foam, having a compressive stress of at least 5 MPa, at a 10 to 15% deformation of a test article comprising the structural foam, and no significant falloff in force level up to a 50% deformation of a test article comprising the structural foam, measured in accordance with ASTM D 1621 at a test temperature of −20° C. or 0° C., wherein said structural foam is obtained by expansion and thermal curing of an expandable, thermally curable composition according to claim 1.
